(19) United States
(12) Patent Application Publication
(10) Pub. No.: US 2017/0012869 A1
(43) Pub. Date: Jan. 12, 2017

(54) FORWARDING TABLE MANAGEMENT IN COMPUTER NETWORKS

(71) Applicant: Microsoft Technology Licensing, LLC, Redmond, WA (US)

(72) Inventors: Darren Loher, Kirkland, WA (US); Gary Ratterree, Sammamish, WA (US); Chen Liu, Sammamish, WA (US)

(21) Appl. No.: 14/796,099

(22) Filed: Jul. 10, 2015

(51) Int. Cl. H04L 12/741; H04L 12/26

(52) U.S. Cl. CPC H04L 45/54; H04L 43/0823

(57) ABSTRACT

Various techniques for managing forwarding tables in computer networks are disclosed herein. In one embodiment, a method includes receiving an indication of a network condition in a computer network having a network node and determining a routing table key based on the received indication of the network condition in the computing network. The routing table key corresponds to a routing table for the network node that is pre-computed under the indicated network condition in the computer network. The method then includes transmitting the determined routing table key to the network node for routing data in the computer network.

### BACKGROUND

Computer networks typically include routers, switches, bridges, or other network nodes that interconnect a number of servers, computers, smartphones, or other computing devices via wired or wireless network links. Each network node can facilitate communications among the computing devices by forwarding messages according to a routing table having a set of entries each defining a network route for reaching particular computing devices in the computer network. Such routing tables can be computed according to various routing protocols. For instance, example protocols for IP networks can include link-state routing protocol, distance vector routing protocol, routing information protocol, and border gateway protocol.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In certain computer networks, a routing table for individual network nodes of a computer network can be computed based on an original state of network links in the computer network. The network nodes can then utilize the computed routing tables for directing network traffic. Typically, when a network link fails, the network nodes related to the failed network link can switch network traffic to other available network routes. A new routing table can be re-computed for directing network traffic through the network nodes based on a current state of network links in the computer network.

One drawback of the foregoing technique is inefficiency in network traffic flow during re-computation of the new routing tables. For example, when a network link fails, the network nodes may direct network traffic via network routes that have higher latencies than other available network routes. Several embodiments of the disclosed technology can at least reduce such inefficiency by storing pre-computed routing tables at each network node with a corresponding routing table key. Upon receiving an indication of a network link failure (or other abnormal network conditions), a network controller can determine a routing table key that corresponds to a routing table pre-computed under a condition of the indicated network link failure. The network controller can then signal the network nodes to switch routing tables based on the determined routing table key. In response, the network nodes can retrieve a new routing table corresponding to the routing table key from a set of stored routing tables at the network nodes, and utilize the retrieved routing table for directing network traffic. As such, network traffic flow in the computer network can be more efficient than in conventional computer networks by utilizing the pre-computed routing tables.

### BRIEF DESCRIPTION OF THE DRAWINGS

FIGS. 1A-1C are schematic diagrams illustrating computer networks utilizing pre-computation of routing tables in accordance with embodiments of the disclosed technology.

FIG. 2 is a block diagram showing software components suitable for the network controller of FIGS. 1A-1C and in accordance with embodiments of the disclosed technology.

FIG. 3 is a block diagram showing software components suitable for the network node of FIGS. 1A-1C and in accordance with embodiments of the disclosed technology.

FIGS. 4A-4B are schematic diagrams showing an example data structure for a routing table set in accordance with embodiments of the disclosed technology.

FIGS. 5-7 are flow diagrams illustrating embodiments of a process of utilizing pre-computation of routing tables in accordance with embodiments of the disclosed technology.

FIG. 8 is a computing device suitable for certain components of the computing frameworks in FIGS. 1A-1C.

### DETAILED DESCRIPTION

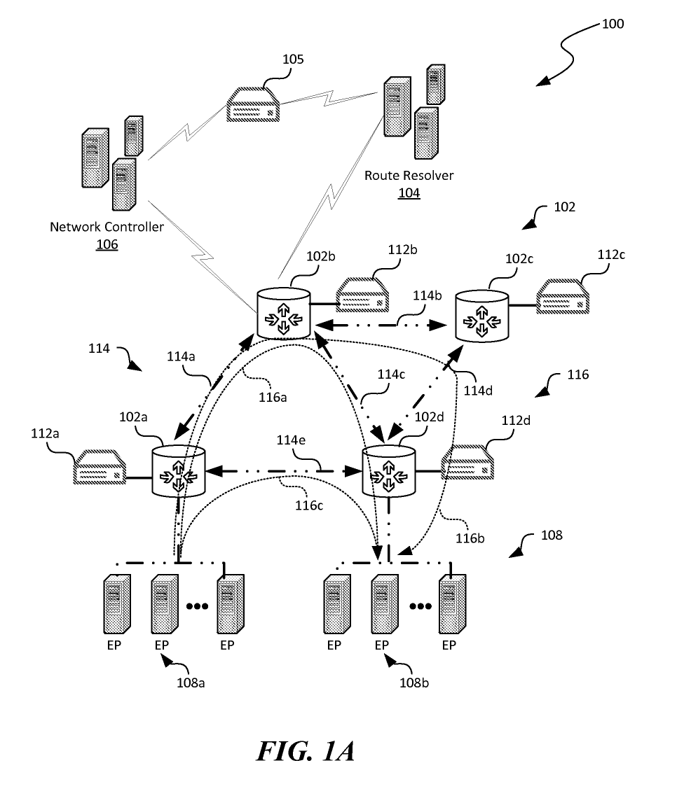

Certain embodiments of systems, devices, components, modules, routines, and processes for utilizing pre-computation of routing tables in computer networks are described below. In the following description, specific details of components are included to provide a thorough understanding of certain embodiments of the disclosed technology. A person skilled in the relevant art will also understand that the disclosed technology may have additional embodiments or may be practiced without several of the details of the embodiments described below with reference to FIGS. 1A-8.

As used herein, the term “computer network” generally refers to an interconnected network that has a plurality of network nodes connecting a plurality of endpoints to one another and to other networks (e.g., the Internet). One example computer network can include a Fast Ethernet network implemented in a datacenter for providing various cloud-based computing services. The term “network node” generally refers to a physical or software emulated network device. Example network nodes include routers, switches, hubs, bridges, load balancers, security gateways, firewalls, network name translators, or name servers.

Each network node may be associated with one or more ports. As used herein, a “port” generally refers to a physical and/or logical communications interface through which data packets and/or other suitable types of messages can be transmitted or received. For example, switching one or more ports can include switching routing data from a first Ethernet port to a second Ethernet port, or switching from a first TCP/IP port to a second TCP/IP port. Also used herein, the term “network link” generally refers to a physical and/or logical network component used to interconnect network nodes in a computer network. A network link can, for example, interconnects corresponding ports of two network nodes. The network nodes can then communicate with each other via the network link according to a suitable link protocol, such as TCP/IP.

The term “endpoint” or “EP” generally refers to a physical or software emulated computing device in a computer network. Example endpoints include network servers, network storage devices, personal computers, mobile computing devices (e.g., smartphones), or virtual machines. Each endpoint may be associated with an endpoint identifier that can have a distinct value in a computer network, a domain in the computer network, or a sub-domain thereof. Example endpoint identifiers can include at least a portion of a label used in a multiprotocol label switched (“MPLS”) network, a stack of labels used in a MPLS network, one or more addresses according to the Internet Protocol (“IP”), one or more virtual IP addresses, one or more tags in a virtual local area network, one or more media access control addresses, one or more Lambda identifiers, one or more connection paths, one or more physical interface identifiers, or one or more packet headers or envelopes.

Also used herein, the term “routing table” generally refers to a set of entries each defining a network route for forwarding data packets or other suitable types of messages to an endpoint in a computer network. Network nodes and endpoints in a computer network can individually contain a routing table that specifies manners of forwarding messages (e.g., packets) to another network node or endpoint in the computer network. In certain embodiments, a routing table can include a plurality of entries individually specifying a network route, forwarding path, physical interface, or logical interface corresponding to a particular value of an endpoint identifier. Example fields of an entry can be as follows:

| | | | |
|---|---|---|---|
| Destination | Incoming | Outgoing | Interface |
| | identifier | identifier | identifier |

In other embodiments, the incoming identifier and the outgoing identifier can have different values. As such, a network node can replace at least a portion of an incoming identifier to generate an outgoing identifier when forwarding a message. In other embodiments, the incoming identifier and the outgoing identifier may have the same values, and example fields of the entry may be as follows instead:

| | | |
|---|---|---|
| Destination | Endpoint | Interface |
| | identifier | identifier |

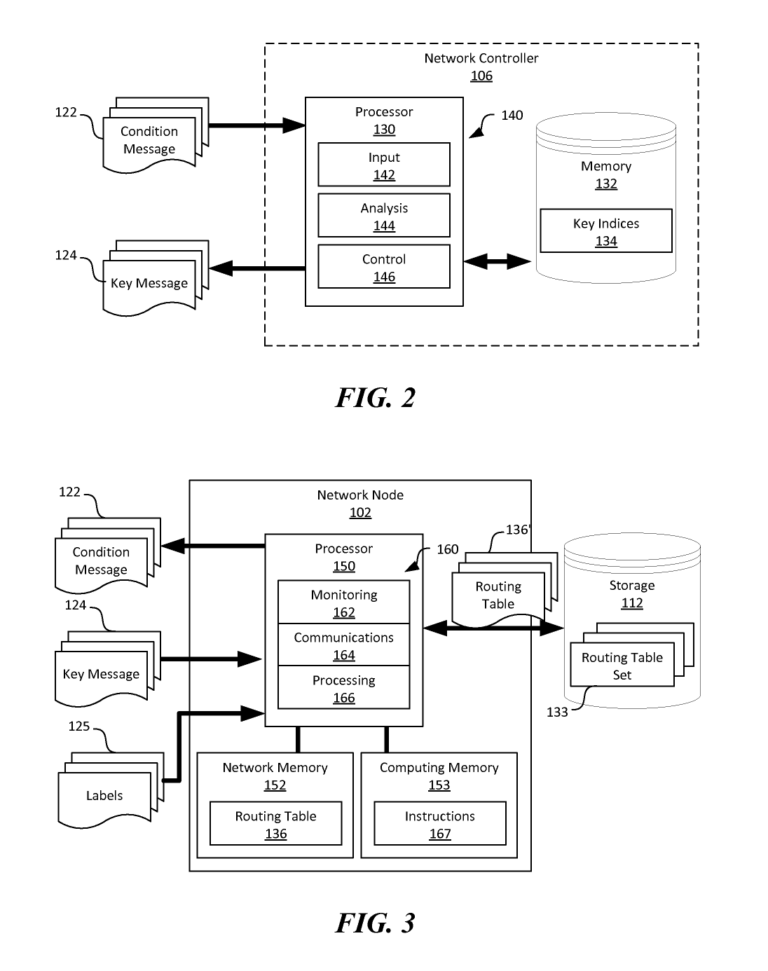

In further embodiments, the entry can also include a network ID filed, a metric field, a next hop field, a quality of service field, and/or other suitable types of field. In yet further embodiments, the routing table may include a plurality of entries that individually reference entries in one or more other tables based on a particular value of an endpoint identifier. One example routing table entry is described in more detail below with reference to FIG. 4B.

FIG. 1A is a schematic diagram illustrating a computer network 100 utilizing pre-computation of routing tables in accordance with embodiments of the disclosed technology. As shown in FIG. 1A, the computer network 100 can include multiple network nodes 102 (identified individually as first, second, third, and fourth network nodes 102a-102d, respectively) interconnecting multiple endpoints 108, a route resolver 104, and a network controller 106. The route resolver 104 and the network controller 106 can each include a server, a virtual machine, or other suitable computing facilities. In FIG. 1A, the route resolver 104 and network controller 106 are shown as being independent from the endpoints 108. In other embodiments, the route resolver 104 and/or the network controller 106 can be hosted on one or more endpoints 108. In further embodiments, the route resolver 104 can be external to the computer network 100. In yet further embodiments, the computer network 100 can also include additional and/or different network nodes 102, endpoints 108, and/or other suitable components.

As shown in FIG. 1A, multiple network links 114 can interconnect ports (not shown) of the network nodes 102 in the computer network 100. For example, a first network link 114a interconnects the first and second network nodes 102a and 102b. A second network link 114b interconnects the second and third network nodes 102b and 102d. A third network link 114c interconnects the second and fourth network nodes 102b and 102d. A fourth network link 114d interconnects the third and fourth network nodes 102c and 102d. A fifth network link 114e interconnects the first and fourth network nodes 102a and 102d. Even though particular connectivity of the network nodes 102 are shown in FIG. 1A, in other embodiments, the network nodes 102 can have cross-links, bypasses, and/or other suitable connectivity arrangements.

The network links 114 can form multiple network paths 116 in the computer network 100. For example, as shown in FIG. 1A, the first and third network links 114a and 114c can form a first network path 116a between a first endpoint 108a and a second endpoint 108b. The first, second, and fourth network links 114a, 114b, and 114d can form a second network path 116b. The fifth network link 116e can form a third network path 116c between the first endpoint 108a and the second endpoint 108b. In FIGS. 1A and 1B, particular network paths 116 are shown for illustration purposes only. In other embodiments, the computer network 100 can also include additional and/or different network paths 116 than those shown in these figures.

In the illustrated embodiment, each network nodes 102 can be coupled to a corresponding storage devices 112 (identified individually as first, second, third, and fourth storage device 112a-112d, respectively). The storage devices 112 can include magnetic disk devices such as flexible disk drives and hard-disk drives, optical disk drives such as compact disk drives or digital versatile disk drives, solid-state drives, and/or other suitable computer readable storage devices. Each storage device 112 can be configured to store a set of pre-computed routing tables retrievable by a corresponding network node 102 based on a routing table key, as described in more detail below. In other embodiments, several network nodes 102 can share one or more of the storage devices 112. In further embodiments, the computer network 100 can also include a network storage device 113 (shown in FIG. 1C) configured as a depository of a portion or all of the pre-computed routing tables for the network nodes 102, as described in more detail below with reference to FIG. 1C.

The route resolver 104 can be configured to compute a set of routing tables for the network nodes 102 under various network conditions or scenarios in the computer network 100. For example, the route resolver 104 can be configured to compute a routing table for the network nodes 102 under one or more of the following examples conditions:
When one of the network links 114 fails;
When two or more of the network links 114 fails;
When one of the network nodes 102 fails;
When two or more of the network nodes 102 fail;
When one network node 102 fails and a network link 114 unrelated to the network node 102 also fails; or
When one or more network links 114 have throughput restrictions.
   In certain embodiments, the route resolver 104 can be configured to iterate through the foregoing example conditions in a parallel fashion by utilizing multiple servers, virtual machines (e.g., multiple endpoints 108), or other suitable computing devices. In other embodiments, the route resolver 104 can also continuously or periodically compute additional and/or different routing tables based on, for example, a detected network condition in the computer network 100.

In certain embodiments, the route resolver 104 can be configured to distribute the computed routing tables to be stored at the storage devices 112 coupled to the network nodes 102. For example, in one embodiment, the route resolver 104 can sort, filter, group, and/or otherwise process the computed routing tables to generate a subset thereof that is related to a particular network node 102. The route resolver 104 can then transmit the generated subset of routing tables to the particular network node 102 according to a network transfer protocol or other suitable protocols. In other embodiments, the route resolver 104 can simply store the computed routing tables in a routing table repository 105. The network controller 106 can then be configured to distribute the routing tables to the network nodes 102 in manners similarly as described above. Even though the route resolver 104 is shown in FIG. 1A as an independent component, in further embodiments, the route resolver 104 can be a part of the network controller 106 and/or an endpoint 108.

The network controller 106 can be configured to monitor for an indication of a detected network condition in the computer network 100 and determine a routing table key based on the detected network condition. The network controller 106 can then be configured to signal the network nodes 102 with the determined routing table key. In response to receiving the routing table key, the network nodes 102 can individually retrieve a corresponding routing table stored at corresponding storage device 112. The network nodes 102 can then replace an existing routing table with the retrieved routing table for direction network traffic in the computer network 100.

FIGS. 1A and 1B illustrate an example of the foregoing operation of the computer network 100. As shown in FIG. 1A, the network nodes 102 can direct network traffic based on a first routing table at each of the network nodes 102. For example, the first routing table can direct network traffic between the first endpoint 108a and the second endpoint 108b through the first network path 116a via the first, second, and fourth network node 102a, 102b, and 102d. As shown in FIG. 1B, upon detection of a link failure 118 in the third network link 114c, the second or fourth network nodes 102b and 102d can signal and indicate to the network controller 106 the detected link failure 118 in a condition message 122. The second or fourth network nodes 102b and 102d can also switch network traffic between them to other available ports, for example, along the second network path 116b using the MPLS link protection or other suitable types of local restoration mechanism that tunnels traffic around a local communications failure. As such, the first and second endpoints 108a and 108b can continue communicating with each other via the third network node 102c until receiving a key message 124 from the network controller 106.

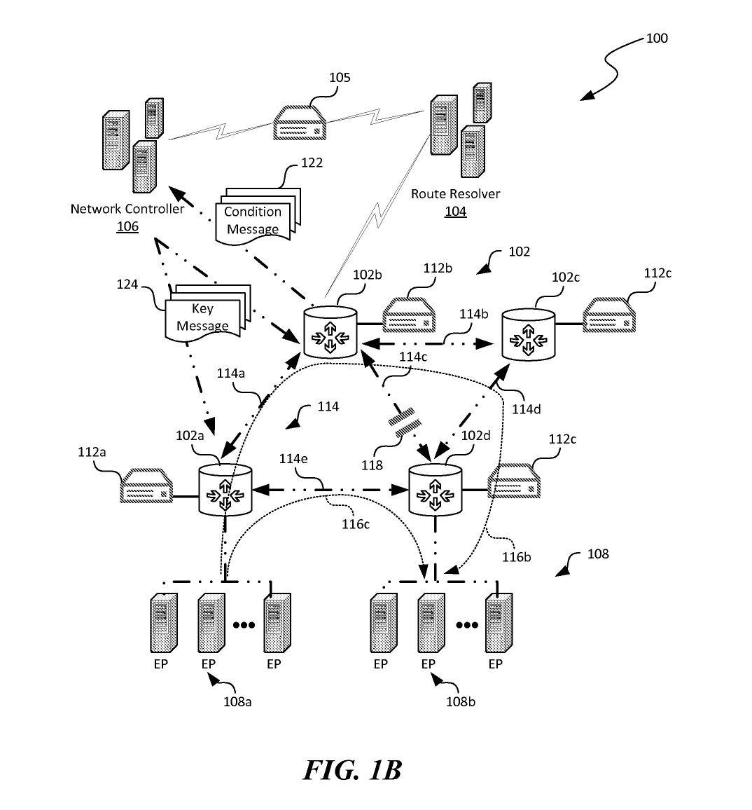

In response to receiving the indication in the condition message 122 of the link failure 118 in the third network link 114c, in one embodiment, the network controller 106 can determine whether the indicated failure 118 corresponds to a routing table key by, for example, searching in a lookup table, querying a database, or via other suitable techniques. The routing table key corresponds to a routing table, for example, pre-computed by the route resolver 104 and stored at the storage devices 112. One example of determining a routing table key is described in more detail below with reference to FIG. 2. Upon determining that the indicated failure 118 corresponds to a routing table key, the network controller 106 transmits a key message 124 containing the determined routing table key to the individual network nodes 102.

Upon receiving the key messages 124, the individual network nodes 102 can then retrieve a corresponding routing table from the corresponding storage device 112 to replace an existing routing table in the network nodes 102 for directing traffic. For example, the network nodes 102 can utilize the retrieved routing table to direct messages between the first and second endpoints 108a and 108b along the third network path 116c via the fifth network link 114e between the first and fourth network nodes 102a and 102d, instead of the second network path 116b. As shown in FIG. 1B, the network traffic between the first and second endpoints 108a and 108b through the third network path 116c can be more efficient than that through the second network path 116b because, for example, the third network path 116c has fewer hop count than the second network path 116b.

In other embodiments, the network controller 106 can also be configured to monitor for the network conditions for a pre-determined period of time (e.g., 50 milliseconds, 100 milliseconds, or 1 second). Upon expiration of the pre-determined period, the network controller 106 can determine a routing table key based on multiple indicated network conditions. For example, the first network node 102a can indicate to the network controller 106 that the fifth network link 114e also fails (not shown) in the computer network 100. Based on failures of both the third and fifth network links 114c and 114e, the network controller 106 can determine a routing table key corresponding to, for instance, the second network path 116b via the first, second, third, and fourth network nodes 102a-102d.

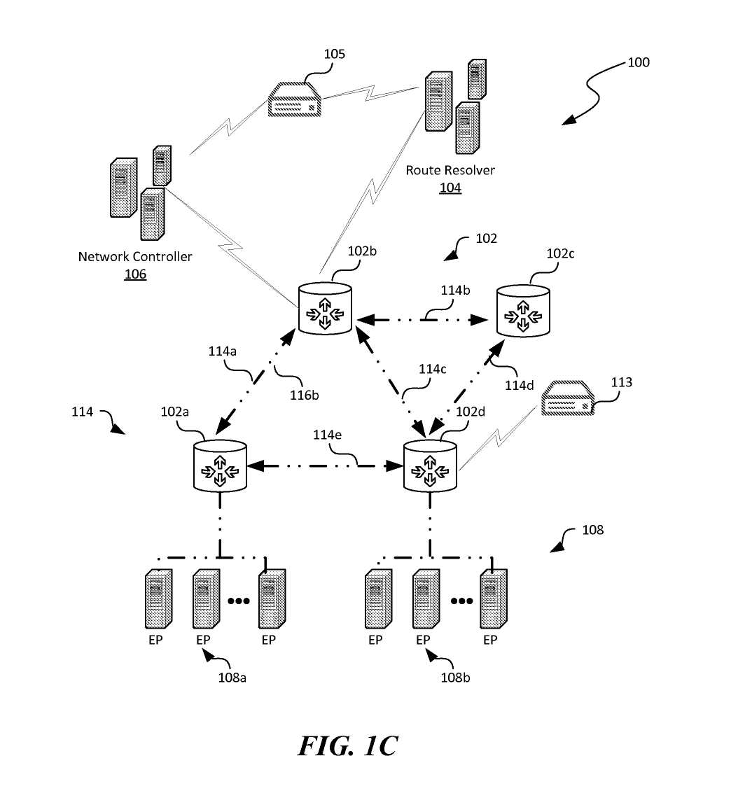

In further embodiments, if the network controller 106 determines that a routing table key corresponding to the indicated network condition(s) does not exist, the network controller 106 can compute a new set of routing tables based on the indicated network condition(s) and transmit the new set of routing tables to the network nodes 102 for directing network traffic. In yet further embodiments, the network controller 106 can signal the route resolver 104 (or other suitable components) for computing the new set of routing tables based on the indicated network condition(s). Suitable software components for the network controller 106 and the network nodes 102 are described in more detail below with reference to FIGS. 2 and 3.

Several embodiments of the computer network 100 described above with reference to FIGS. 1A and 1B can have faster convergence of a desired pattern of network traffic than conventional networks. As described above, upon detecting a network condition such as a link failure, the network controller 106 can determine a routing table key that corresponds to a routing table pre-computed under a condition of the indicated link failure based on suitable network performance metrics and/or other criteria. Thus, the pre-computed routing table corresponds to a desired pattern of network traffic in the computer network under the indicated network condition. The network controller 106 can then signal the network nodes 102 to switch to the determined routing table based on the routing table key. Thus, time-consuming ad hoc computation of the routing table for the indicated network condition can be avoided. As such, network traffic in the computer network 100 can converge more quickly to the desired pattern than conventional networks.

Even though each network node 102 is shown in FIGS. 1A and 1B as having a corresponding storage device 112, in other embodiments, the network nodes 102 can be operatively coupled to a shared storage device. As shown in FIG. 1C, the network nodes 102 can be operatively coupled to a network storage device 113. The network storage device 113 can be a storage server, a file server, or other suitable types of storage components. Similar to the storage devices 112 in FIGS. 1A and 1B, the network storage device 113 can be configured to store sets of routing tables for individual network nodes 102. In further embodiments, the network storage device 113 can be eliminated. Instead, the routing table repository 105 can be configured to store and allow retrieval of the sets of routing tables for individual network nodes 102.

FIG. 2 is a block diagram showing software components 140 suitable for the network controller 106 of FIGS. 1A-1C and in accordance with embodiments of the disclosed technology. In FIG. 2 and in other Figures hereinafter, individual software components, objects, classes, modules, and routines may be a computer program, procedure, or process written as source code in C, C++, Java, and/or other suitable programming languages. A component may include, without limitation, one or more modules, objects, classes, routines, properties, processes, threads, executables, libraries, or other components. Components may be in source or binary form. Components may include aspects of source code before compilation (e.g., classes, properties, procedures, routines), compiled binary units (e.g., libraries, executables), or artifacts instantiated and used at runtime (e.g., objects, processes, threads). Components within a system may take different forms within the system. As one example, a system comprising a first component, a second component and a third component can, without limitation, encompass a system that has the first component being a property in source code, the second component being a binary compiled library, and the third component being a thread created at runtime.

The computer program, procedure, or process may be compiled into object, intermediate, or machine code and presented for execution by one or more processors of a personal computer, a network server, a laptop computer, a smartphone, and/or other suitable computing devices. Equally, components may include hardware circuitry. A person of ordinary skill in the art would recognize that hardware can be considered fossilized software, and software can be considered liquefied hardware. As just one example, software instructions in a component can be burned to a Programmable Logic Array circuit, or can be designed as a hardware circuit with appropriate integrated circuits. Equally, hardware can be emulated by software. Various implementations of source, intermediate, and/or object code and associated data may be stored in a computer memory that includes read-only memory, random-access memory, magnetic disk storage media, optical storage media, flash memory devices, and/or other suitable computer readable storage media excluding propagated signals.

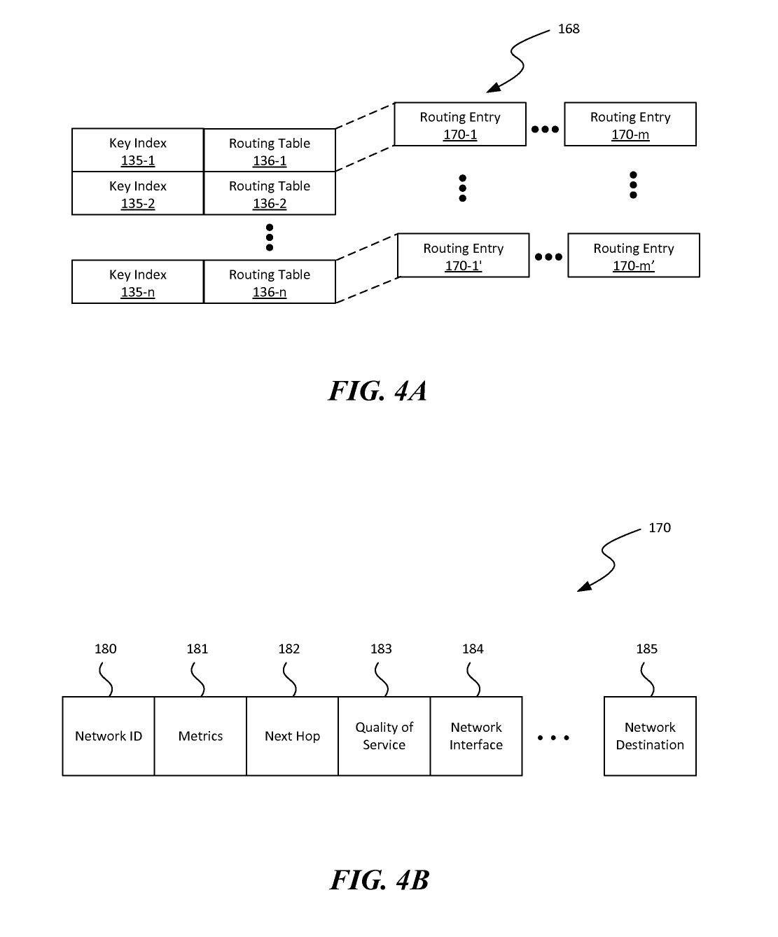

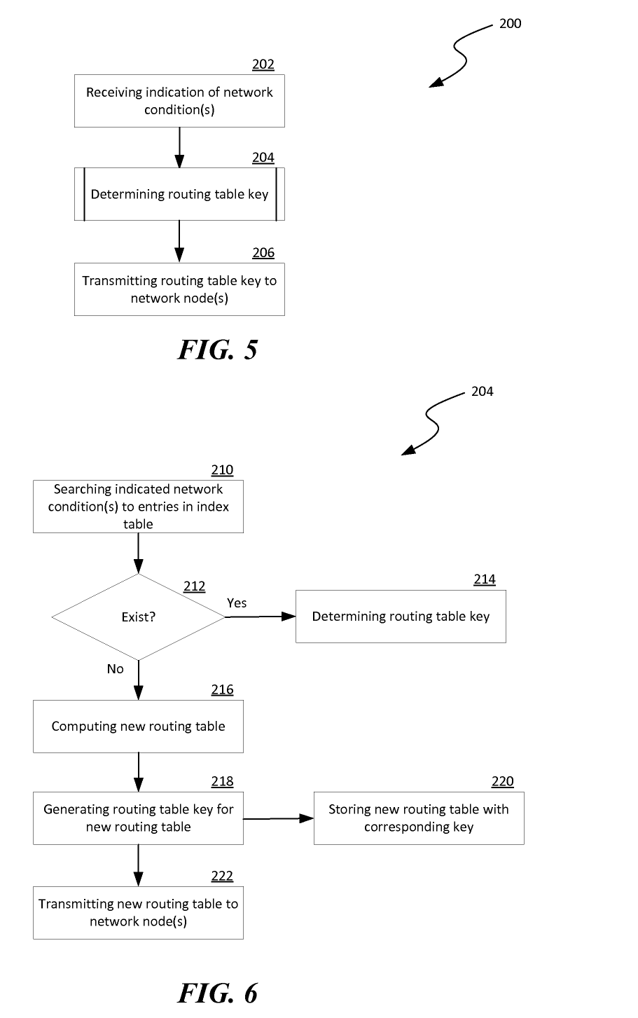

As shown in FIG. 2, the network controller 106 can include a processor 130 operatively coupled to a memory 132. The processor 130 can include a microprocessor, a field-programmable gate array, and/or other suitable logic devices. The memory 132 can include volatile and/or nonvolatile media (e.g., ROM; RAM, magnetic disk storage media; optical storage media; flash memory devices, and/or other suitable storage media) and/or other types of computer-readable storage media configured to store data received from, as well as instructions for, the processor 130 (e.g., instructions for performing the methods discussed below with reference to FIGS. 5 and 6).

As shown in FIG. 2, the memory 132 can also contain records of a set of key indices 134. The key indices 134 can be organized as a table, a list, an array, or other suitable data structure with entries each containing a routing table index and one or more associated network conditions. For instance, example key indices 134 for the computer network 100 shown in FIGS. 1A-1C can be as follows:

| Index | Network Entity | Network Condition |
|---|---|---|
| 1 | Second and fourth network | Failure in network link |
| | nodes 102b and 102d | 114c |
| 2 | Third network node 102c | Failure in network node |
| 3 | First and forth network | Network traffic congestion |
| | nodes 102a and 102d | |

In the above example, the key indices 134 are organized as a table with an index field, a network entity field, and a network condition field. The index field can be configured to contain a numerical, an alphanumerical, or other suitable types of index values. The network entity field can be configured to contain one or more identifications of network nodes 102 (FIG. 1B) or endpoints 108 (FIG. 1B) involved in a network condition. The network condition field can contain data indicating a link failure, a network node failure, a network traffic congestion, or other suitable types of network conditions. In other embodiments, the key indices 134 can be organized as a graph table, array, or other suitable structures with additional and/or different fields.

The processor 130 can execute instructions to provide a plurality of software components 140 configured to facilitate determining a routing table key based on an indicated network condition in the condition message 122. As shown in FIG. 2, the software components 140 include an input component 142, an analysis component 144, and a control component 146 operatively coupled to one another. In one embodiment, all of the software components 140 can reside on a single computing device (e.g., a server). In other embodiments, the software components 140 can also reside on multiple distinct servers or computing devices. In further embodiments, the software components 140 may also include network interface components and/or other suitable modules or components (not shown).

The input component 142 can be configured to receive the condition message 122 from one or more network nodes 102 (FIG. 1A). The condition message 122 can be configured to indicate detection of a network condition in the computer network 100 (FIG. 1A). In one example, the condition message 122 can include multiple data fields as follows:

| | | |
|---|---|---|
| Time Stamp | Network | Network |
| | Entity | Condition |

In the example above, the time stamp field can contain a time stamp of the condition message 122 or a time stamp of the detected network condition. The network entity field and the network condition field can be generally similar to those described above with reference to the key indices 134. In other example, the condition message 122 can also include a traffic data field (e.g., containing a detected bandwidth of a network link 114 in FIG. 1A), a historical traffic data field (e.g., a number of packets transmitted during a period of time via a network link 114), and/or other suitable data fields. In one embodiment, the input component 142 can include a network interface module configured to receive the condition message 122 configured according to TCP/IP or other suitable network protocols. In other embodiments, the input component 142 can also include other suitable modules. The input component 142 can then forward the received condition message 122 to the analysis component 144.

The analysis component 144 can be configured to determine a routing table key based on the indication of the network condition contained in the received condition message 122. In one embodiment, the analysis component 144 can identify one or more associated network entities and a network condition by, for example, parsing the received condition message 122. The analysis component 144 can then search, query, or otherwise consult the key indices 134 in the memory 132 to determine a routing table key that corresponds to a routing table for the network nodes 102, and the routing table is pre-computed (e.g., by the route resolver 104 of FIG. 1A) under the indicated network condition in the computer network 100. For instance, in the example shown in FIG. 2B, the analysis component 144 can determine from the received condition message 122 that a link failure 118 is detected between the second and fourth network nodes 102b and 102d. Based on the determination, the analysis component 144 can perform a lookup or query in the example table of the key indices 134 to determine that the routing table key “1” corresponds to the indicated network condition in the condition message 122. The analysis component 144 can then forward the determined routing table key to the control component 146 for further processing.

The control component 146 can be configured to generate and transmit a key message 124 containing the determined routing table key to the network nodes 102. In certain embodiments, the key message 124 can include a single data field containing the determine routing table key. In other embodiments, the key message 124 can also include, for example, a time stamp field associated with the key message 124, an effective time field containing data indicating when the routing table key is effective, and/or other suitable data fields. Based on the received key message 124, individual network nodes 102 can retrieve a corresponding pre-computed routing table based on the routing table key, as described in more detail below with reference to FIG. 3.

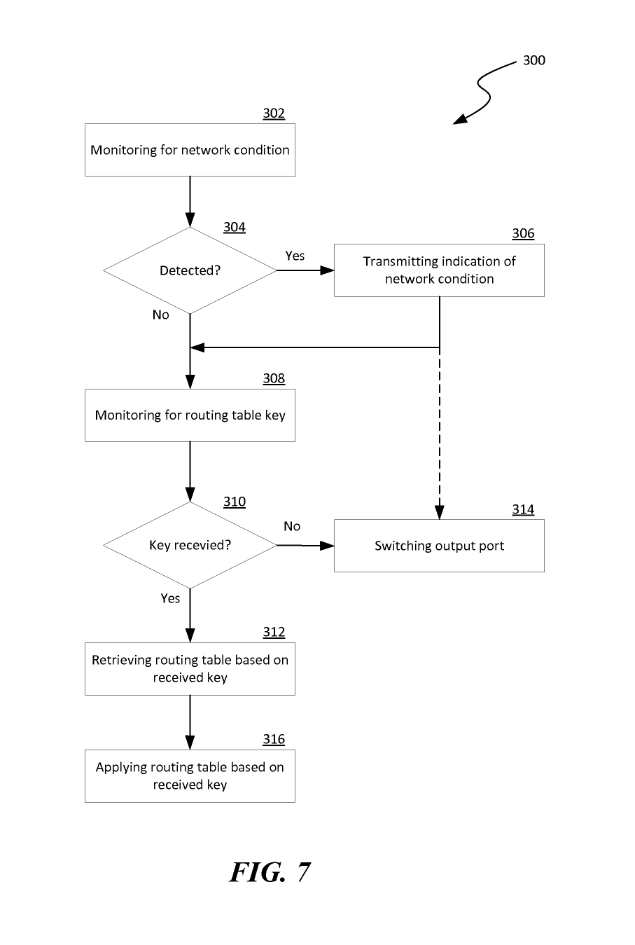

FIG. 3 is a block diagram showing software components 140 suitable for the network node 102 of FIGS. 1A-1C and in accordance with embodiments of the disclosed technology. As shown in FIG. 3, the network node 102 can include a processor 150 operatively coupled to a network memory 152 and a computing memory 153. The processor 150 can include a microprocessor, a field-programmable gate array, and/or other suitable logic devices. The network memory 152 can include ternary content addressable memory (“TCAM”), content addressable memory (“CAM”), or other suitable types of associative memory. The network memory 152 can be configured to support high-speed searching operations, for example, by comparing input search data (e.g., labels 125) against a table of stored data (e.g., a routing table 136), and returning an address of matching data or the matching data (e.g., a next hop or a network path 116 in FIG. 1A). Typically, the network memory 152 are costly and not readily expandable. The computing memory 153 can include volatile and/or nonvolatile media (e.g., ROM; RAM, magnetic disk storage media; optical storage media; flash memory devices, and/or other suitable storage media) and/or other types of computer-readable storage media configured to store data received from, as well as instructions 167 for, the processor 150 (e.g., instructions for performing the methods discussed below with reference to FIG. 7). Typically, the computing memory 153 can be less costly than the network memory 152 and can be readily expendable. As shown in FIG. 3, the network memory 152 can contain a routing table 136 that the processor 150 can utilize to forward network traffic in the computer network 100 (FIG. 1A). Example routing tables 136 are described in more detail below with reference to FIGS. 4A and 4B.

The processor 150 can execute instructions to provide a plurality of software components 160 configured to facilitate replacing, switching, or otherwise modifying the routing table 136 in the network memory 152. As shown in FIG. 3, the software components 160 include a monitoring component 162, a communications component 164, and a processing component 166. In other embodiments, the software components 160 can also include input/output, security, and/or other suitable types of components.

The monitoring component 162 can be configured to detect one or more network conditions in the computer network 100. For example, the monitoring component 162 can include one or more port monitors configured to detect a current condition of data traffic via a particular port of the network node 102. The communications component 164 can be configured to (1) transmit a condition message 122 containing an indication of the detected one or more network conditions to the network controller 106 (FIG. 1A); and (2) receive a key message 124 containing a determined routing table key from the network controller 106.

The processing component 166 can be configured to retrieve a routing table 136′ from a routing table set 133 containing multiple routing tables stored in the storage devices 112 based on the routing table key contained in the received key message 124. The processing component 166 can also be configured replace an original routing table 136 in the network memory 152 with the retrieved routing table 136′. The processing component 166 can then utilize the routing table 136′ for directing network traffic through the network node 102.

FIG. 4A is a schematic diagram showing an example data structure for a routing table set 133. As shown in FIG. 4A, the routing table set 133 can include multiple entries 168 each having a key index field 135 (shown as key indices 135-1 to 135-n) and a routing table 136 (shown as routing tables 136-1 to 136-n). Each routing table 136 can include multiple routing entries 170 (shown as routing entries 170-1 to 170-m). As shown in FIG. 4B, in one embodiment, each of the routing entries 170 can also include a network ID filed 180, a metrics field 181, a next hop field 182, a quality of service field 183, a network interface field 184, and a network destination field 185. The network ID field 180 can contain, for example, a subnet ID, a virtual network ID, a label, a stack of labels, or other suitable network ID. The metrics field 181 can contain metric data used by a network node 102 (FIG. 1A) to make routing decisions. Example metrics data can include data representing path length, bandwidth, load, hop count, path cost, delay, maximum transmission unit, reliability and communications cost, and/or other suitable types of data. The next hop field 182 can contain a network node ID that is the next stop for a message. The quality of service field 183 can contain a value of quality of service associated with a data packet. The network interface field 184 can contain an interface ID (e.g., a first Ethernet card) through which network traffic can flow. The network destination field 185 can contain an endpoint identification. In other examples, a routing entry can also include a network mask field, a network gateway field, and/or other suitable fields.

FIG. 5 is a flow diagram illustrating embodiments of a process 200 of utilizing pre-computation of routing tables in accordance with embodiments of the disclosed technology. Even though various embodiments of the process 200 are described below with reference to the computer network 100 of FIGS. 1A-1C and the software components 140 and 160 of FIGS. 2 and 3, respectively, in other embodiments, the process 200 may be performed with other suitable types of computing frameworks, systems, components, or modules.

As shown in FIG. 5, the process 200 can include receiving an indication of one or more network conditions at stage 202. For example, in one embodiment, the indication of the network conditions can be received via one or more condition messages 122 (FIG. 1B) from the network nodes 102 (FIG. 1B). In other embodiments, the indication of the network conditions can also be obtained via, for instance, network monitors, traffic sniffers, and/or other suitable components.

The process 200 can then include determining a routing table key based on the indicated network conditions at stage 204. The routing table key can correspond to a routing table for the network nodes 102 pre-computed by, for example, the route solver 104 executed in a datacenter. One example technique of determining the routing table key is described in more detail below with reference to FIG. 6. The process 200 can then include transmitting the determined routing table key to the network nodes 102 at stage 206.

FIG. 6 is a flow diagram illustrating embodiments of a process 204 of determining a routing table key in accordance with embodiments of the disclosed technology. As shown in FIG. 6, the process 204 can include searching the indicated network conditions to entries in an index table having multiple network conditions with corresponding routing table keys. The process 204 can then include a decision stage 212 to determine whether the indicated network conditions exist in the index table. In response to determining that an entry exists in the index table, the process 204 includes determining the routing table key corresponding to the located entry in the index table.

In response to determining that an entry does not exist in the index table, the process 204 can include computing, for instance, using the route resolver 104 of FIG. 1A, a new routing table based on the indicated network condition at stage 216. The process 204 can also include generating a routing table key for the new routing table at stage 218 and storing the new routing table with the corresponding routing table key in, for instance, the routing table repository 105 of FIG. 1A. The process 204 can then include transmitting the new routing table to the network nodes 102 at stage 222.

FIG. 7 is a flow diagram illustrating embodiments of a process 300 of managing routing tables at a network node in accordance with embodiments of the disclosed technology. As shown in FIG. 7, the process 300 can include monitoring for one or more network conditions at stage 302, for example, by monitoring one or more ports at the network node. The process 300 can then include a decision stage 304 to determine if a network condition is detected. In response to determining that a network condition is detected, the process 300 can include transmitting an indication of the detected network condition to, for example, the network controller 106 of FIG. 1A, at stage 306. Optionally, the process 300 can also include switching one or more output ports at stage 314 using the MPLS link protection or other suitable types of local restoration mechanism that tunnels traffic around a local communications failure in response to the detected network condition.

The process 300 can also include monitoring for a key message 124 (FIG. 1B) containing a routing table key at stage 308. In response to determining that a key message 124 is received at stage 310, the process 300 can include retrieving a routing table from, for example, the corresponding storage device 112 or the network storage device 113, based on the routing table key contained in the key message 124. The process 300 can then include applying the retrieved routing table in the network node by, for instance, replacing an original routing table with the retrieved routing table. The network node can then utilize the retrieved routing table for directing network traffic through the network node. In response to determining that a key message 124 is not received, the process 300 can include switching one or more output ports at stage 314.

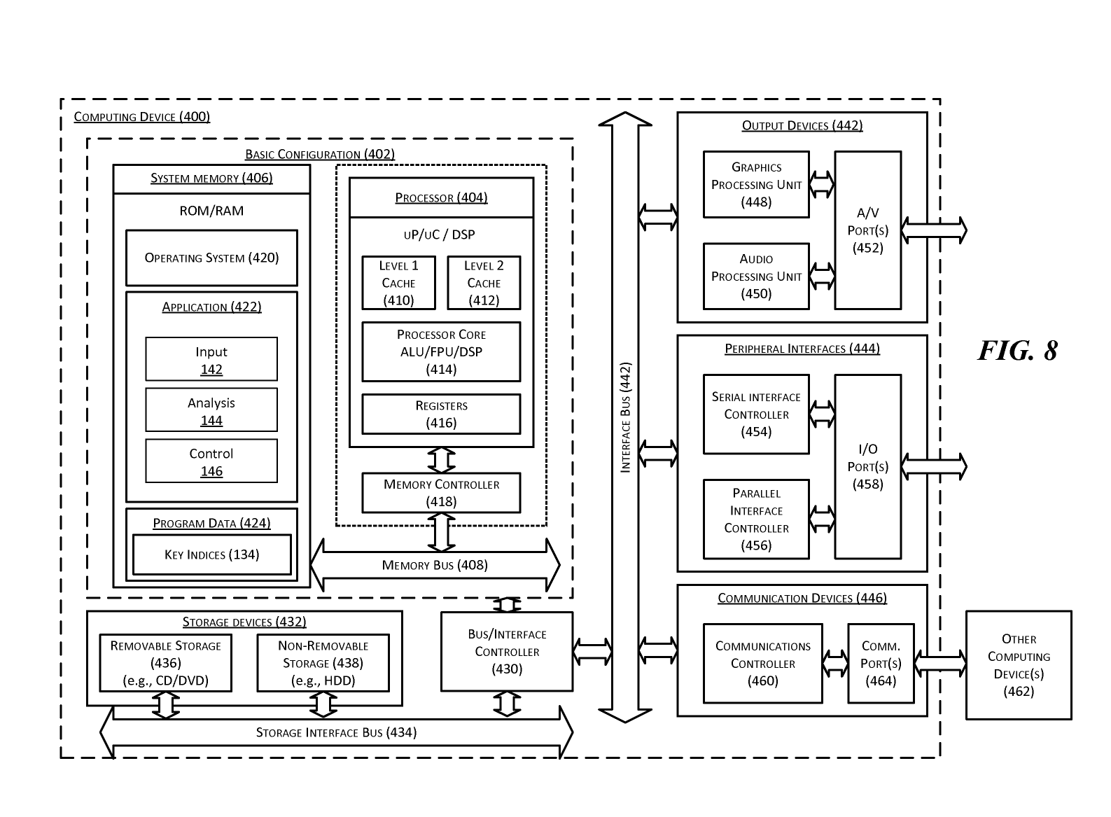

FIG. 8 is a computing device 400 suitable for certain components of the computer network 100 in FIGS. 1A-1C. For example, the computing device 400 may be suitable for the route resolver 104, the network controller 106, the network nodes 102, or the endpoints 108 of FIGS. 1A-1C. In a very basic configuration 402, computing device 400 typically includes one or more processors 404 and a system memory 406. A memory bus 408 may be used for communicating between processor 404 and system memory 406.

Depending on the desired configuration, the processor 404 may be of any type including but not limited to a microprocessor (μP), a microcontroller (μC), a digital signal processor (DSP), or any combination thereof. The processor 404 may include one more levels of caching, such as a level one cache 410 and a level two cache 412, a processor core 414, and registers 416. An example processor core 414 may include an arithmetic logic unit (ALU), a floating point unit (FPU), a digital signal processing core (DSP Core), or any combination thereof. An example memory controller 418 may also be used with processor 404, or in some implementations memory controller 418 may be an internal part of processor 404.

Depending on the desired configuration, the system memory 406 may be of any type including but not limited to volatile memory (such as RAM), non-volatile memory (such as ROM, flash memory, etc.) or any combination thereof. The system memory 406 can include an operating system 420, one or more applications 422, and program data 424. In one example, the one or more applications 422 can include, for example, the input component 142, the analysis component 144, and the control component 146 of the network controller 106 in FIG. 2. In another example, though not shown in FIG. 8, the one or more applications 422 can also include the monitoring component 162, the communications component 164, and the processing component 166 of the network node 102 in FIG. 3. The program data 424 may include, for example, the key indices 134. This described basic configuration 402 is illustrated in FIG. 9 by those components within the inner dashed line.

The computing device 400 may have additional features or functionality, and additional interfaces to facilitate communications between basic configuration 402 and any other devices and interfaces. For example, a bus/interface controller 430 may be used to facilitate communications between the basic configuration 402 and one or more data storage devices 432 via a storage interface bus 434. The data storage devices 432 may be removable storage devices 436, non-removable storage devices 438, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 406, removable storage devices 436, and non-removable storage devices 438 are examples of computer readable storage media. Computer readable storage media include storage hardware or device(s), examples of which include, but not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other media which may be used to store the desired information and which may be accessed by computing device 400. Any such computer readable storage media may be a part of computing device 400. The term “computer readable storage medium” excludes propagated signals and communication media.

The computing device 400 may also include an interface bus 440 for facilitating communication from various interface devices (e.g., output devices 442, peripheral interfaces 444, and communication devices 446) to the basic configuration 402 via bus/interface controller 430. Example output devices 442 include a graphics processing unit 448 and an audio processing unit 450, which may be configured to communicate to various external devices such as a display or speakers via one or more A/V ports 452. Example peripheral interfaces 444 include a serial interface controller 454 or a parallel interface controller 456, which may be configured to communicate with external devices such as input devices (e.g., keyboard, mouse, pen, voice input device, touch input device, etc.) or other peripheral devices (e.g., printer, scanner, etc.) via one or more I/O ports 458. An example communication device 446 includes a communications controller 460, which may be arranged to facilitate communications with one or more other computing devices 462 over a network communication link via one or more communication ports 464. For instance, in certain embodiments in which the computing device 400 represents, for example, one of the network nodes 102 of FIG. 1A, the computing device 400 can contain multiple network ports 464. The communications controller 460 can be implemented to contain TCAM/CAM or other suitable types of associative memories. The storage of the routing table set 133 (FIG. 3) can be performed in the system memory 406 and/or storage devices 432.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 400 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. The computing device 400 may also be implemented as a personal computer including both laptop computer and non-laptop computer configurations.

Specific embodiments of the technology have been described above for purposes of illustration. However, various modifications may be made without deviating from the foregoing disclosure. In addition, many of the elements of one embodiment may be combined with other embodiments in addition to or in lieu of the elements of the other embodiments. Accordingly, the technology is not limited except as by the appended claims.

I/We claim:

1. A computing device in a computer network having a network node, the computing device comprising:
an input component configured to receive an indication of a network condition in a computer network having a network node;
an analysis component configured to determine a routing table key based on the received indication of the network condition in the computing network, the routing table key corresponding to a routing table for the network node, wherein the routing table is pre-computed under the indicated network condition in the computer network; and
a control component configured to transmit the determined routing table key to the network node for routing data in the computer network.

2. The computing device of claim 1 wherein the pre-computed routing table is computed by a routing table solver executed in a datacenter.

3. The computing device of claim 1 wherein the transmitted routing table key is used by the network node in the computer network to replace a first routing table to a second routing table stored at the network node.

4. The computing device of claim 1 wherein the transmitted routing table key is used by the network node to retrieve a routing table from a plurality of routing tables stored at the network node and to route data based on the retrieved routing table.

5. The computing device of claim 1 wherein:
the input component is configured to receive a first indication of a first network condition in the computer network and a second indication of a second network condition in the computer network; and
the analysis component is configured to determine the routing table key based on both the indicated first and second network conditions.

6. The computing device of claim 1 wherein:
the indicated network condition includes a network link failure in the computer network; and
the analysis component is configured to determine the routing table key corresponding to a routing table pre-computed under a condition of the network link failure.

7. The computing device of claim 1, further comprising:
a route resolver configured to compute additional routing tables based on the received indication of the network condition in the computer network; and
the control component is configured to transmit the computed additional routing tables to the network node for storage.

8. A method for routing data in a computer network, comprising:
receiving an indication of a network condition in a computer network having a network node;
determining a routing table key based on the received indication of the network condition in the computing network, the routing table key corresponding to a routing table for the network node, wherein the routing table is pre-computed under the indicated network condition in the computer network; and
transmitting the determined routing table key to the network node for routing data in the computer network.

9. The method of claim 1 wherein the pre-computed routing table is computed by a routing table solver executed in a datacenter.

10. The method of claim 1 wherein the transmitted routing table key is used by the network node in the computer network to replace a first routing table to a second routing table stored at the network node.

11. The method of claim 1 wherein the transmitted routing table key is used by the network node to retrieve a routing table from a plurality of routing tables stored at th9e network node and to route data based on the retrieved routing table.

12. The method of claim 1 wherein:
receiving the indication includes receiving a first indication of a first network condition in the computer network;
the method further includes receiving a second indication of a second network condition in the computer network; and
determining the routing table key includes determining the routing table key based on both the indicated first and second network conditions.

13. The method of claim 1 wherein:
the indicated network condition includes a network link failure in the computer network; and
determining the routing table key includes determining the routing table key corresponding to a routing table pre-computed under a condition of the network link failure.

14. The method of claim 1, further comprising:
computing additional routing tables based on the received indication of the network condition in the computer network; and
transmitting the computed additional routing tables to the network node for storage.

15. A method for routing data through a network node, comprising:
monitoring for a network condition related to routing data through the network node;
in response to a monitored network condition, indicating the monitored network condition to a network controller;
determining whether a key message is received in response to indicating the monitored network condition to a network controller;
in response to determining that a key message is received, retrieving a routing table based on a routing table key contained in the received key message; and
routing data through the network node utilizing the retrieved routing table.

16. The method of claim 15 wherein monitoring for the network condition includes monitoring for a link failure through a first port of the network node, and wherein the method further includes switching routed data from the first port to a second port.

17. The method of claim 15 wherein monitoring for the network condition includes monitoring for a link failure through a first port of the network node, and wherein the method further includes in response to determining that a key message is not received, switching routed data from the first port to a second port different than the first port.

18. The method of claim 15 wherein:
monitoring for the network condition includes monitoring for a link failure through a first port of the network node;
the method further includes switching routed data from the first port to a second port in response to the monitored network condition; and
routing data through the network node utilizing the retrieved routing table includes routing data through the network node utilizing the retrieved routing table via a third port different than the second port.

19. The method of claim 15 wherein routing data through the network node utilizing the retrieved routing table includes retrieving the routing table from a routing table set having a plurality of pre-computed routing tables stored at a storage device operatively coupled to the network node.

20. The method of claim 15 wherein routing data through the network node utilizing the retrieved routing table includes:
retrieving the routing table from a routing table set having a plurality of pre-computed routing tables stored at a storage device operatively coupled to the network node; and
replacing an original routing table at the network node with the retrieved routing table.
